(19) United States
(12) Patent Application Publication
(10) Pub. No.: US 2008/0038304 A1
(43) Pub. Date: Feb. 14, 2008

(54) MICROENCAPSULATED COMPOSITIONS FOR TOPICALLY TREATING AN ANIMAL AGAINST PARASITE INFESTATION

(75) Inventor: Larry Nouvel, Plano, TX (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: SERGEANT'S PET CARE PRODUCTS INC., Omaha, NE (US)

(21) Appl. No.: 11/464,228

(22) Filed: Aug. 14, 2006

(51) Int. Cl. A01N 25/08

(52) U.S. Cl. 424/409

(57) ABSTRACT

The invention provides aqueous liquid dispersions of microcapsules comprising at least one anti-parasitic agent. The microcapsules have a core material that contains one or more anti-parasitic agents. The core material is encapsulated by a shell wall that is substantially hydrophilic and generally does not dissolve in water. The microcapsules may be used to treat animals against a variety of parasites.

### FIELD OF THE INVENTION

The present invention generally relates to aqueous dispersions of microcapules comprising anti-parasitic agents. In particular, the aqueous dispersions of microcapsules may be used to treat animals against a variety of parasite infections.

### BACKGROUND OF THE INVENTION

The infestation of animals with parasites is highly undesirable. Meat, milk and fiber producing animals, such as suckling, growing, grazing and feed lot cattle, domesticated swine, sheep, goats, poultry and companion animals such as horses, dogs and cats all can serve as hosts for a large number of internal and external parasites. In farm animals, the presence of parasites diminishes the overall production of meat, milk and/or wool. In the case of companion animals, the presence of parasites can lead to discomfort, impaired health and performance, and even death. Each year, for example, millions of dogs and cats in the United States are treated for fleas, ticks, and mites. Flea, tick and mite infestations cause great discomfort, transmit disease to pets and humans, and significantly interfere with the relationship between people and their pets. Societal changes have brought pets into the family home, intensifying the need for disease prevention.

Several classes of insecticides are effective for combating parasites. For example, insect growth regulators, pyrethrins, pyrethroids, organophosphates, and organocarbamates are used to treat animals for parasite infestation. Various methods of formulating anti-parasitic agents are known in the art. These formulations include oral treatments, dietary supplements, powders, topical treatments (e.g., dips and pour ons), and shampoos. While each of these formulations has some efficacy in combating parasites, most of the treatments are effective for a short period of time, often lasting only a few hours to a few days.

Several spot-on anti-parasitic formulations, however, effectively combat parasites for a prolonged period of time, often remaining effective for over one month. Spot on formulation typically have an anti-parasitic agent dissolved in one or more organic carriers. While spot on formulations are effective and convenient, many of the organic carriers utilized in the formulations cause irritancy or toxicity to the animal. As such, there is a need in the art for both more effective and less irritant or toxic spot on formulations that combat a broad spectrum of endoparasites and ectoparasites in birds and mammals.

### DETAILED DESCRIPTION OF THE PREFERRED EMBODIMENTS

The invention provides aqueous liquid dispersions of microcapsules comprising at least one anti-parasitic agent. Generally, the microcapsules have a core material that contains one or more anti-parasitic agents. The core material is encapsulated by a thin, semi-permeable shell wall that is substantially hydrophilic and generally does not dissolve in water. Because the shell wall does not dissolve in water, an aqueous carrier that is not toxic to the animal may be used in lieu of toxic organic carriers presently used in traditional spot on formulations. Advantageously, because the core material is encapsulated, a relatively high concentration of anti-parasitic agent may be administered to the animal in a controlled release fashion.

### I. Microcapsule

The microcapsule of the present invention generally comprises a core material comprising an anti-parasitic agent and a shell wall that encapsulates the core material.

(a) Core Material

The core material may comprise a liquid or a solid. Useful solid core materials, for example, may comprise anti-parasitic agents in crystal form. Generally speaking, useful core materials that comprise liquids include those that are a single phase liquid at temperatures of less than about 100° C. In other embodiments, the core material is a liquid at temperatures of less than about 80° C. In a further embodiment, the core material is a liquid at temperatures of less than about 65° C. In still another embodiment, the core material is a liquid at temperatures of less than about 50° C. The core material may also comprise solids in a liquid phase. Whether liquid or solids in a liquid phase, the core material preferably has a viscosity such that it flows easily when applied topically to the animal. By way of example, the core material generally may have a viscosity of less than about 2000 centipoise (e.g., less than about 1800, 1400, 1100, 900, 800, 700, 600 or even 500 centipoise). The viscosity may be determined by methods generally known in the art.

The core material comprises one or more anti-parasitic agents, and may include a solvent. The term “anti-parasitic agent,” as used herein, is used in its broadest sense to include agents used as active ingredients of products to treat or prevent animal infestation by any of a variety of parasites or other pests. The parasite may be an ectoparasite, such as, for example fleas, ticks, lice, mosquitoes, and mites. Alternatively, the parasite may be an endoparasite, such as, for example, nematodes, roundworms, Ancyclostoma, Anecator, Ascaris, Strongyloides, Trichiris, Enterobius, and filariar worms.

Suitable classes of anti-parasitic agents that may be utilized in the core material include pyrethrins (e.g., pyrethin I, pyrethrin II, cinevin I, cinevin II, jasmolin I, and jasmolin II), pyrethroids (e.g., cypermethrin, imiprothrin, lambda cyhalothrin, permethrin, chlorpyrifos, phenothrin, and diazinon), N-phenylpyrazole derivatives (i.e., fipronil), organophosphates or organocarbamates (i.e., dichlorvos, cythioate, diazinon, malathion, carbaryl, fenthione, methylcarbamate, and prolate), imidacloprid, arylheterocycles, insect growth regulators (i.e, agridyne, diofenolan, fenoxycarb, hydroprene, kinoprene, methoprene, pyriproxyfen, tetrahydroazadirachtin, chlorfluazuron, cyromazine, diflubenzuron, fluazuron, flucycloxuron, flufenoxuron, hexaflumuron, ifenuron, tebufenozide, and triflumuron), amitraz, selamectin, and nitenpyram. In an exemplary embodiment, the anti-parasitic agent may be etofenprox.

Examples of additional anti-parasitic agents that can be used in the present invention include one or more of: (1) fungicides such as, for example, (a) nitrophenol derivatives such as dinocap, binapacryl, and 2-sec-butyl-4,6-dinitrophenyl isopropyl carbonate; (b) heterocyclic structures such as captan folpet, glyodine, dithianon, thioquinox, benomyl, thiabendazole, vinolozolin, iprodione, procymidone, triadimenol, triadimefon, bitertanol, fluoroimide, triarimol, cycloheximide, ethirimol, dodemorph, dimethomorph, thifuzamide, and, quinomethionate; (c) miscellaneous halogenated fungicides such as: chloranil, dichlone, chloroneb, tricamba, dichloran, and polychloronitrobenzenes; (d) fungicidal antibiotics such as: griseofulvin, kasugamycin and streptomycin; (e) miscellaneous fungicides such as: diphenyl sulfone, dodine, ethylene bis-isothiocyanate sulfide, methoxyl, 1-thiocyano-2,4-dinitrobenzene, 1-phenylthiosemicarbazide, thiophanate-methyl, and cymoxanil; as well as acylalanines such as, furalaxyl, cyprofuram, ofurace, benalaxyl, and oxadixyl; fluazinam, flumetover, phenylbenzamide derivatives such as those disclosed in EP 578586 A1, amino acid derivatives such as valine derivatives disclosed in EP 550788 A1, methoxyacrylates such as methyl (E)-2-(2-(6-(2-cyanophenoxy)pyrimidin-4-yloxy)phenyl)-3-methoxyacrylate; benzo(1,2,3)thiadiazole-7-carbothioic acid S-methyl ester: propamocarb; imazalil; carbendazim; myclobutanil; fenbuconazole; tridemorph; pyrazophos; fenarimol; fenpiclonil; and pyrimethanil; and (2) insecticides, including acephate, aldicarb, alpha-cypermethrin, azinphos-methyl, bifenthrin, binapacryl, buprofezin, carbaryl, carbofuran, cartap, chlorpyrifos, chlorpyrifos methyl, clofentezine, cyfluthrin, cyhexatin, cypermethrin, cyphenothrin, deltamethrin, demeton, demeton-S-methyl, demeton-O-methyl, demeton-S, demeton-S-methyl sulfoxid, demephion-O, demephion-S, dialifor, diazinon, dicofol, dicrotophos, diflubenzuron, dimethoate, dinocap, endosulfan, endothion, esfenvalerate, ethiofencarb, ethion, ethoate-methyl, ethoprop, etrimfos, fenamiphos, fenazaflor, fenbutatin-oxide, fenitrothion, fenoxycarb, fensulfothion, fenthion, fenvalerate, flucycloxuron, flufenoxuron, fluvalinate, fonofos, fosmethilan, furathiocarb, hexythiazox, isazophos, isofenphos, isoxathion, methamidophos, methidathion, methiocarb, methomyl, methoxyfenozide, methyl parathion, mevinphos, mexacarbate, monocrotophos, nicotine, omethoate, oxamyl, parathion, permethrin, phorate, phosalone, phosmet, phosphamidon, pirimicarb, pirimiphos-ethyl, profenofos, promecarb, propargite, pyridaben, resmethrin, rotenone, tebufenozide, temephos, TEPP, terbufos, thiodicarb, tolclofos-methyl, triazamate, triazophos, andvamidothion. In another exemplary embodiment, the anti-parasitic agent may be cyphenothrin.

Other suitable anti-parasitic agents that can be used in the present invention include peppermint, clove, cinnamon, rosemary, wintergreen, and cornmint oil alone or in combination with one or more natural or synthetic plant essential oil compounds and/or derivatives thereof, including racemic mixtures, enantiomers, diastereomers, hydrates, salts, solvates and metabolites, among others. As used herein, the term “plant essential oil” or “plant essential oil compound” (which shall include derivatives thereof) generally refers to a monocyclic, carbocyclic ring structure having six-members and substituted by at least one oxygenated or hydroxyl functional moiety. Examples of plant essential oils encompassed within the present invention, include, but are not limited to, members selected from the group consisting of aldehyde C16 (pure),.alpha.-terpineol, amyl cinnamic aldehyde, amyl salicylate, anisic aldehyde, benzyl alcohol, benzyl acetate, cinnamaldehyde, cinnamic alcohol, carvacrol, carveol, citral, citronellal, citronellol, p-cymene, diethyl phthalate, dimethyl salicylate, dipropylene glycol, eucalyptol (cineole), eugenol, iso-eugenol, galaxolide, geraniol, guaiacol, ionone, menthol, menthyl salicylate, methyl anthranilate, methyl ionone, methyl salicylate, a-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thyme oil, thymol, metabolites of trans-anethole, vanillin, ethyl vanillin, and the like. As these plant essential oil compounds are known and used for other non-pesticidal uses, they may be prepared by a skilled artisan by employing known methods or obtained from commercially available sources.

The concentration of anti-parasitic agent comprising the core material can and will vary depending upon its desired application. In some embodiments, the concentration of the anti-parasitic agent in the core material or in the microcapsule is from about 10% to about 90% by weight of the microcapsule. In additional embodiments, the concentration of the anti-parasitic agent in the core material or in the microcapsule is greater than about 20% by weight. In yet another embodiment, the concentration of the anti-parasitic agent in the core material or in the microcapsule is from about 25% to about 60% by weight of the microcapsule. In still another embodiment, the concentration of the anti-parasitic agent in the core material or in the microcapsule is from about 40% to about 60% by weight of the microcapsule.

The core material may optionally comprise a diluent. The diluent may be added to change the solubility parameter characteristics of the core material to increase or decrease the release rate of the anti-parasitic agent from the microcapsule, once release has been initiated. For example, the core material may comprise between about 0% and about 10% by weight of a diluent, for example between 0.1 and about 8% by weight, between about 0.5% and about 6% by weight, or between about 1% and 5% by weight.

Typically, a diluent may be selected from essentially any of those known in the art, the compatibility of the diluent with the core material (e.g., the active) and/or the shell wall being determined, for example, experimentally using means standard in the art (see, e.g., U.S. patent application Ser. No. 10/728,654 filed Dec. 5, 2003 and U.S. Pat. No. 5,925,595, the entire contents of which are incorporated herein for all relevant purposes). Exemplary diluents include, for example: alkyl-substituted biphenyl compounds (e.g., SureSol 370, commercially available from Koch Co.); normal paraffin oil (e.g., Norpar 15, commercially available from Exxon); mineral oil (e.g., Orchex 629, commercially available from Exxon); isoparaffin oils (e.g., Isopar V, commercially available from Exxon); aliphatic fluids or oils (e.g., Exxsol D110, commercially available from Exxon); alkyl acetates (e.g., Exxate 1000, commercially available from Exxon); aromatic fluids or oils (A 200, commercially available from Exxon); citrate esters (e.g., Citroflex A4, commercially available from Morflex); and, plasticizing fluids or oils used in, for examples, plastics (typically high boiling point esters).

(b) Shell Wall

As will be appreciated by a skilled artisan, the materials that comprise the shell wall can and will vary depending upon a variety of factors, including, the core material, the desired release rate and concentration of the anti-parasitic agent, the parasitic target, and the animal being treated. Suitable materials include natural or synthetic polymers that are substantially hydrophilic and that generally do not dissolve in water. Such materials include water-soluble polymers such as a water-soluble natural polymer, a water-soluble semi-synthetic polymer, a water-soluble synthetic polymer and the like. Alternatively, the shell wall material may be a wax. These materials may or may not be mixed with emulsifiers.

Suitable examples of water-soluble natural polymer include starches, mannans, extracts from seaweeds, viscous substances from plants or microbial proteins. Exemplary starches include sweet potato starch, potato starch, tapioca starch, wheat starch, and corn starch. By way of example, a suitable mannan includes konjak mannan. Suitable extracts from seaweed include, for example, funori, agar, and alginate or sodium alginate. Examples of viscous substances from plants include Abelmoschus manihot, tragacanth gum, and arabic gum. Suitable examples of proteins, include, but are not limited to gelatin, casein, and collagen.

Examples of synthetic water-soluble polymers suitable for use in the invention include polyvinyl alcohol, polyethylene oxide, polyacrylamide, sodium polyacrylate, polyvinyl pyrollidone, copolymer of methyl methacrylate, butyl methacrylate and dimethylaminoethyl methacrylate, and polycaprolactam.

Suitable examples of semi-synthetic water-soluble polymers include, but are not limited to, water-soluble semi-synthetic celluloses, and water-soluble semi-synthetic starches. The water-soluble semi-synthetic celluloses include viscose, methylcellulose, ethylcellulose, hydroxyethylcelllulose, carboxymethylcellulose, hydroxypropylcellulose, and hydroxypropylmethylcellulose. Suitable water-soluble semi-synthetic starches include water-soluble starch, carboxymethylated starch, dialdehyde-starch, dextrin, oxidized starch, etherified starch, and esterified starch. Among those, water-soluble semi-synthetic starches are preferable, such as, for example, dextrin. A variety of types of dextrans are suitable for use in the invention, including, amylodextrin, erythrodextrin, achrodextrin, cyclodextrin, and maltodextrin. Examples of suitable cyclodextrins, include, but are not limited to, α-, β-, and γ-cyclodextrins having six (α-), seven (β-), or eight (γ-) anhydroglucose units in the ring structure and combinations thereof.

In other embodiments, the shell wall may comprise a polyfunctional amine-isocyanate polymer such as those disclosed in U.S. Pat. No. 5,925,595 and U.S. patent application Ser. No. 10/728,654, the entire contents of which are incorporated by reference herein for all relevant purposes.

Without being bound by any particular theory, the shell wall may encapsulate the anti-parasitic agent-containing core material such that, at the time of applicatoin, molecular diffusion of the anti-parasitic agent through the shell wall is the predominant release mechanism. Thus for this embodiment, the shell is preferably structurally intact; that is, the shell is preferably not mechanically harmed or chemically eroded so as to allow the anti-parasitic to release by a flow mechanism. Further, the shell is preferably substantially free of defects, such as micropores and fissures, of a size that would allow the core material to be released by flow. In this regard it is to be noted that, as used herein, “flow” of the core material from the microcapsule generally refers to a stream of the material that drains or escapes through a structural opening in the shell wall. In contrast, “molecular diffusion” generally refers to a molecule of, for example, an anti-parasitic agent, which is absorbed into the shell wall at the interior surface of the wall and desorbed from the shell wall at the exterior surface of the wall.

Alternatively, the shell wall may encapsulates the anti-parasitic agent-containing core material such that, at the time of application, the anti-parasitic agent substantially flows through the shell wall as a predominant release mechanism. As will be appreciated by a skilled artisan, the release mechanism may also comprise a combination of molecular diffusion and flow.

Irrespective of the release mechanism, the shell wall is generally semi-permeable. In this regard it is to be noted that, as used herein, “semi-permeable” generally refers to a microcapsule wherein the anti-parasitic agent-containing core material has an intermediate release rate between a substantially impermeable microcapsule and a microcapsule that essentially allows the immediate release of core material (i.e., a microcapsule that releases the anti-parasitic agent-containing core material in less than about 24 hours, about 18 hours, about 12 hours, or even about 6 hours). For example, a “semi-permeable” microcapsule may release half of the anti-parasitic agent-containing core material in between about 1 to about 150 days, about 10 to about 125 days, about 25 to about 100 days, or about 50 to about 75 days.

(c) Physical Parameters of the Microcapsules

The size and shape of the microcapsules can and will vary without departing from the scope of the present invention. Generally, their size may be measured in terms of the diameter of a sphere that occupies the same volume as the microcapsule being measured. The characteristic diameter of a microcapsule may be directly determined, for example, by inspection of a photomicrograph. Typically, a microcapsule of the present invention may have a diameter between about 0.1 and about 200 microns. More preferably a microcapsule may have a diameter between about 0.5 or 1 micron and about 30 microns.

The size distribution of a sample of microcapsules may be measured using a particle analyzer by a laser light scattering technique. Generally, particle size analyzers are programmed to analyze particles as though they were perfect spheres and to report a volumetric diameter distribution for a sample on a volumetric basis. An example of a suitable particle analyzer is the Coulter LS-130 Particle Analyzer. This device uses laser light at around a 750 mm wavelength to size particles from about 0.4 microns to about 900 microns in diameters by light diffraction.

The thickness of a microcapsule shell wall may be an important factor in some instances. Shell walls that are too thin may have insufficient integrity to withstand mechanical forces and remain intact. Shell walls that lack mechanical integrity may be prone to defects and destruction, causing the core material to be released prematurely. Shell walls that may be too thick are uneconomical, any may delay release of the core materials.

The thickness of a microcapsule shell wall of the present invention may be expressed as a percentage representing the ratio of the weight of the shell to the weight of the core material. Accordingly, the weight ratio of shell to core may be less than about 65% (e.g., between about 1% or 5% and about 65%). Alternatively, the weight ratio may be less than about 35% (e.g., between about 1% and 35%). In still another embodiment, the weight ratio is less than about 15% (e.g., between about 1% and 15%). Generally then, for microcapsules having a wall to core weight ratio between about 5% and about 15%, the equivalent thickness of shells is between about 1.5% and about 5% of the diameter of a microcapsule.

By way of example, the equivalent shell wall thickness of a microcapsule having a diameter between about 0.1 and about 60 microns may typically be between about 0.001 and 4 microns. Likewise, for microcapsule diameters between about 1 micron and 30 microns, the equivalent shell wall thickness may be between about 0.01 and 2. For microcapsule diameters between about 1 micron and 6 microns, the equivalent shell wall thickness may typically be between about 0.01 and 0.4 microns thick.

(d) Methods for Microencapsulation

The present invention is further directed to an encapsulation method that produces mechanically strong microcapsules having a core material contained therein. Release of the core material is typically controlled by the shell wall of the microcapsule, without the need for mechanical release. Generally speaking, the core material may be encapsulated by the shell wall to form a microcapsule of the invention by physical or chemical methods known in the art. As will be appreciated by a skilled artisan, the encapsulation method can and will vary depending upon the compounds used to form the core material and shell wall, and the desired physical characteristics of the microcapsules themselves (i.e., degree of permeability and size).

(i) Encapsulation by Physical Methods

The encapsulation may be accomplished by a physical method. Suitable physical methods include, for example, air suspension coating, centrifugal extrusion, and spray drying.

In an air suspension process, the core material is typically coated with the shell wall while suspended in an upward-moving air stream. The core materials are typically supported by a perforated plate having different patterns of holes inside and outside a cylindrical insert. The holes are generally of a size such that sufficient air is permitted to rise through the outer annular space to fluidize the settling core materials. Most of the rising air, which is generally heated, flows inside the cylinder, causing the core materials to rise rapidly. At the top, as the air stream diverges and slows, the core materials settle back onto the outer bed and move downward to repeat the cycle. Generally, the core materials pass through the inner cylinder many times in a few minutes until the encapsulation process is completed.

When the core material comprises a liquid, centrifugal extrusion may be used for encapsulation. In this process, core materials comprising liquids are encapsulated using a rotating extrusion head containing concentric nozzles. A jet of core liquid is surrounded by a shell wall solution. As the jet moves through the air it breaks, owing to Rayleigh instability, into droplets of core, each coated with the shell wall solution. While the droplets are in flight, a molten shell wall may be hardened or a solvent may be evaporated from the shell wall solution to form microcapsules.

Spray drying, in certain embodiments, may be used for encapsulation. Briefly, spray drying may serve as a microencapsulation technique when a core material is dissolved or suspended in a shell wall comprising a melt or polymer solution and becomes trapped in the dried particle to form a microcapsule.

(ii) Encapsulation by Chemical Methods

The encapsulation may also be accomplished by a chemical method. Suitable chemical methods include, for example, in-situ polymerization, matrix polymerization, and interfacial polymerization.

In some embodiments, the chemical encapsulation method may be in-situ polymerization. In in-situ polymerization, typically direct polymerization of a shell material comprising a monomer is carried out on the core material surface. By way of example, core materials having cellulose fibers may be encapsulated in polyethylene while immersed in an organic acid.

Matrix polymerization may be utilized in some embodiments for encapsulation. In this process, a core material is imbedded in a polymeric matrix during formation of the microcapsules. A simple method of this type is spray-drying, in which the microcapsule is formed by evaporation of the solvent from the matrix material. Alternatively, the solidification of the matrix also can be caused by a chemical change.

An aqueous dispersion of the microcapsules of the invention may be produced in an interfacial polymerization reaction system. Generally speaking, in interfacial polymerization, two reactants (i.e., a core material and shell wall) in a polycondensation meet at an interface and react rapidly. The basis of this method is the classical Schotten Baumann reaction between an acid chloride and a compound containing an active hydrogen atom, such as an amine or alcohol, polyesters, polyurea, polyurethane. Under the right conditions, thin flexible shell walls form rapidly at the interface.

A more detailed illustration of an encapsulation process suitable for use in the invention is shown in the examples.

### II. Aqueous Microcapsule Composition

Generally speaking, the topical composition of the invention comprises a liquid dispersion of microcapsules. The liquid medium wherein the microcapsules are dispersed is preferably an aqueous carrier (e.g., water). The dispersion may optionally be further formulated with additives as described herein or as otherwise known in the art.

The aqueous dispersion of microcapsules of the present invention may be formulated to further optimize its shelf stability and safe use. Dispersants and thickeners are useful to inhibit the agglomeration and settling of the microcapsules. This function is facilitated by the chemical structure of these additives as well as by equalizing the densities of the aqueous and microcapsule phases. Anti-packing agents are useful when the microcapsules are to be redispersed. A pH buffer can be used to maintain the pH of the dispersion in a range that is safe for animal skin.

Dispersants may be non-ionic or anionic. Useful dispersants include gelatin, casein, polyvinyl alcohol, alkylated polyvinyl pyrrolidone polymers, maleic anhydride-methyl vinyl ether copolymers, styrene-maleic anhydride copolymers, maleic acid-butadiene and diisobutylene copolymers, sodium and calcium lignosulfonates, sulfonated naphthalene-formaldehyde condensates, modified starches, and modified cellulosics like hydroxyethyl or hydroxypropyl cellulose, and sodium carboxy methyl cellulose.

Thickeners may be useful in retarding the settling process by increasing the viscosity of the aqueous phase. By way of example, thickeners may be utilized to increase the viscosity of the microcapsule dispersion to a range between about 100 cps to about 400 cps, as tested with a Haake Rotovisco Viscometer and measured at about 10° C. by a spindle rotating at about 45 rpm. Suitable examples of useful shear-thinning thickeners include water-soluble, guar- or xanthan-based gums (e.g. Kelzan from CPKelco), cellulose ethers (e.g. METHOCEL from Dow), modified cellulosics and polymers (e.g. Aqualon thickeners from Hercules), and microcrystalline cellulose anti-packing agents.

Anti-packing agents facilitate redispersion of microcapsules upon agitation of a formulation in which the microcapsules have settled. Suitable anti-packing agents are, for example, cellulose, clay, silicon dioxide, insoluble starch particles, and insoluble metal oxides (e.g. aluminum oxide or iron oxide).

The aqueous dispersion of microcapsules may optionally comprise a quarternary ammonium salt. Suitable quarternary ammonium salts include, for example, oleyldimethylammonium chloride, cetyltrimethylammonium chloride, and tallowalyltrimethylammonium chloride.

### III. Treatment of Animals Against Parasite Infestation

The compositions disclosed herein (i.e., microcapsule dispersions) are useful as topical, controlled-release anti-parasitic agents. In an exemplary embodiment, the composition may be applied topically to an animal in an effective amount for the control of the varieties of parasites and pests for which the composition has been selected. Because the average release characteristics of a population of microcapsules of the present invention may be controlled release, it is believed that improved bioefficacy of a given anti-parasitic agent may be achieved. The compositions of the invention may be used on a variety of mammals and birds including, companion animals (e.g., dogs, cats, birds, and rabbits), zoo animals, wild animals, and a farm animals (e.g., sheep, pigs, cattle, horses, and poultry).

A composition of the invention may be applied topically to an animal according to practices known to those skilled in the art. Briefly, the composition may be applied to any of a variety of spots on the animal's skin. In an exemplary embodiment, the composition may be applied between the two shoulders of the animal. While not wishing to be bound by theory, it is believed that the microencapsulated anti-parasitic agents dissolve in the natural oils of the animal's skin, fur or feathers. From there, the anti-parasitic agent distribute around the animal's body through the sebaceous glands of the skin. The anti-parasitic agent also may remain in the sebaceous glands.

Administration of the topical composition may be intermittent in time and may be administered daily, weekly, biweekly, monthly, bimonthly, quarterly, or even for longer durations of time. The time period between treatments depends upon factors such as the parasite(s) or pests being treated, the degree of infestation, the type of mammal or bird and the environment where it resides. It is well within the skill level of the practitioner to determine a specific administration period for a particular situation. In an exemplary embodiment, for example, the treatment for dogs and cats is on a monthly basis.

The effective amount of microcapsules to be applied to an animal is dependent upon the identity of the encapsulated anti-parasitic agent, the release rate of the microcapsules, the animal species to be treated, and environmental conditions. Generally, a dose of microencapsulated anti-parasitic agent may range from about 0.01 to about 1000 mg per kg of the animal's body weight. But the amount may vary by an order of magnitude or more in some instances without departing from the scope of the invention. Since the encapsulated anti-parasitic agent of the present invention may achieve greater effectiveness than unencapsulated anti-parasitic agent at equivalent application rates, an encapsulated anti-parasitic agent may be expected to achieve the same effectiveness as unencapsulated anti-parasitic agents at lower rates.

The term “half-life,” as used herein, is employed as an indicator of release rate. The “half-life” of a microcapsule is defined as the time required for one-half the mass of a compound initially present in the core material to release from a microcapsule. Half-life is therefore inversely related to release rate: a smaller half-life values represent release rates greater than those represented by larger half-life values. The half-life of an aqueous dispersion of microcapsules, for which the total initial mass of encapsulated anti-parasitic agent is known, can be experimentally determined. The cumulative mass of anti-parasitic agent released over time from microcapsules immersed in a relatively large volume of water at a constant temperature may be measured and recorded. This data may then be analyzed in various ways of differing complexity. According to one approach, the cumulative mass value is converted into a percent of initial anti-parasitic agent released and plotted versus the square root of time, and the half-life can be determined from the equation of a line fit to the data at the point which corresponds to a 50% release.

The half-life of the microcapsules of present invention may vary widely, depending upon the desired result. For example, in some embodiments, the microcapsules may be used soon after preparation, while in others they may be stored for several days, months or even years before use. Accordingly, when in storage (i.e., prior to application to the animal), the microcapsules of the present invention exhibit enhanced stability, having a half-life for example of at least about 6 months, about 12 months, about 18 months, about 24 months or more. In contrast, once these microcapsules have been applied and activated, they may exhibit a half-life of, for example, at least about 5 days, about 10 days, about 20 days, about 40 days, about 60 days or more (e.g., a half-life in the range of about 10 days to about 60 days, or about 20 days to about 40 days).

Accordingly, it is to be noted that the preferred half-life of microcapsules to be applied to animals depends upon numerous factors, including the identity of the animal, the identity of the anti-parasitic agent, storage duration, and environmental conditions. One skilled in the art may take such factors into account and select a anti-parasitic formulation of the present invention having a useful half-life.

### EXAMPLES

The preparation of a microcapsule dispersion of the invention may be achieved in accordance with the example detailed below.

In general, there are two steps utilized for preparation of a microcapsule according to this example. First, an emulsion of the core material and the shell wall is prepared, and second, the emulsion is spray-dried. An emulsion is prepared with the core material and a hydrophilic shell wall material, such as cyclodextran. Suitable devices that may be used for making an emulsion include a homomixer, a microfluidizer, a die mill, etc. The emulsion can be prepared while heating, if desired. The amount of water used in this step may be optimally determined based on the types of the shell wall material and/or the core material used. The amount is selected so that the concentrations of the shell wall material and the core material are not so high as to become an obstacle in the drying step. The concentration of water may be 50% or less. The viscosity of the resulting emulsion is not more than 2,000 cp (25° C.), preferably not more than 1,000 cp.

The core material may be in solid form or liquid form. If the core material is in solid form, it will be ground to a powder having an average particle diameter of 0.1 to 10 microns. These particles may be combined with the water-soluble shell wall material described above to create an emulsion or suspension. The emulsion or suspension may be produced to have the average particle diameter of the emulsified particles between 0.1 to 5 μm, preferably 0.2 to 3 μm.

Once the emulsion or suspension is prepared as described above, it is spray dried. Spray drying is effective to obtain a microcapsule with a diameter within a given range. In spray drying, the emulsion is atomized by pumping the emulsion through a rotating disk into the heated chamber of a spray dryer. In the heated chamber, water is dissolved, creating a dried shell wall material that has encapsulated the core material.

The temperature at which the spray-drying is performed depends on the solvent (typically, water) used in the emulsion step. For example, the drying step may be carried out at a temperature range of between about 50° to about 250° C., preferably between about 70° to about 200° C. The rotations speed of the spray-dryer atomizer can be adjusted so that the diameter of the microcapsule is not more than 50 μm, preferably in the range of between about 3 to about 45 μm, more preferably between about 5 to 40 μm.

The spray-dried material can be continuously collected from the spray-dryer. The dried shell wall material, which encapsulates the core material, is mixed with water to form a suspension of microcapsules. The suspension is delivered to the animal's skin, where the core material slowly releases over time.

Alternatively, liquid core material is mixed with shell wall materials and water. The combination is mixed under high sheer and under high speed to create a continuous aqueous phase and a non-continuous phase comprising microcapsules of core material and shell. This suspension of microcapsules is then applied to animal's skin where the core is released over time.

What is claimed Is:

1. A topical composition for treating an animal against a parasite, the composition comprising:
(a) a microcapsule comprising a core material comprising an anti-parasitic agent; and a shell wall that encapsulates the core material; and
(b) an aqueous carrier.

2. The topical composition of claim 1, wherein the anti-parasitic agent is effective against an ectoparasite selected from the group consisting of fleas, ticks, lice, flies, mosquitoes, and mites.

3. The topical composition of claim 1, wherein the anti-parasitic agent is effective against an endoparasite selected from the group consisting of nematodes, roundworms, Ancylostoma, Anecator, Ascaris, Strongyloides, Trichinella, Capillaria, Toxocara, Toxascaris, Trichiris, Enterobius, and filarial worms.

4. The topical composition of claim 1, wherein the anti-parasitic agent is selected from the group consisting of an insecticide, a fungicide, a bacteriocide and combinations thereof.

5. The topical composition of claim 1, wherein the core material comprises a solvent to solubilize the anti-parasitic agent.

6. The topical composition of claim 1, wherein the concentration of the anti-parasitic agent in the core material is from about 10% to about 100% by weight of the core.

7. The topical composition of claim 1, wherein the concentration of the anti-parasitic agent in the core material is greater than about 20% by weight of the core.

8. The topical composition of claim 1, wherein the concentration of the anti-parasitic agent in the core material is from about 25% to about 60% by weight of the core.

9. The topical composition of claim 1, wherein the aqueous carrier comprises water.

10. The topical composition of claim 1, wherein the shell wall is substantially hydrophilic and does not dissolve in water.

11. The topical composition of claim 1, wherein the shell wall is formed from materials selected from the group consisting of alginates, proteins, carbohydrates, gelatin, and cellulose, or modifications thereof.

12. The topical composition of claim 1, wherein the shell wall comprises an emulsifier.

13. The topical composition of claim 1, wherein the shell wall is a dextrin selected from cyclodextrin and maltodextrin.

14. The topical composition of claim 1, wherein the shell wall is comprised of a wax.

15. The topical composition of claim 1, wherein the shell wall is comprised of an interfacial polymerization between two phases.

16. The topical composition of claim 1, wherein the microcapsule has an average diameter ranging from about 1 micron to about 30 microns.

17. The topical composition of claim 1, wherein, upon application, the microcapsule has a half-life ranging from about 5 to about 150 days.

18. The topical composition of claim 1, wherein, prior to application, the microcapsule has a half-life of at least about 6 months.

19. The topical composition of claim 1, wherein the shell wall is substantially impermeable with respect to the core material prior to application.

20. The topical composition of claim 1, wherein the microcapsule is capable of releasing the anti-parasitic agent by a mechanism consisting essentially of molecular diffusion.

21. The topical composition of claim 1, further comprising an agent that maintains the pH of the composition in the acidic range.

22. The topical composition of claim 1, further comprising a bacteriocide, a fungicide, or a virocide.

23. The topical composition of claim 22, further comprising a quaternary ammonium salt.

24. The topical composition of claim 1, further comprising an insect growth regulator.

25. The topical composition of claim 1, further comprising a crystallization inhibitor.

26. The topical composition of claim 1, further comprising an antioxidant.

27. The topical composition of claim 1, further comprising at least two anti-parasitic agents that are each effective against different species of parasites.

28. The topical composition of claim 27, wherein the two anti-parasitic agents are encapsulated within the same microcapsule.

29. The topical composition of claim 27, wherein the two anti-parasitic agents are encapsulated by two separate microcapsules.

30. A method for treating an animal against a parasite, the method comprising topically applying to the animal a composition comprising an aqueous dispersion of microcapsules, the microcapsules comprising a core material comprising an anti-parasitic agent that is encapsulated by a shell wall.

31. The method of claim 30, wherein the animal is selected from the group consisting of a companion animal, a zoo animal, a wild animal, and a farm animal.

32. The method of claim 30, wherein the animal is dog or a cat.

33. The method of claim 30, wherein the anti-parasitic agent is effective against an ectoparasite selected from the group consisting of fleas, ticks, lice, flies, mosquitoes, and mites.

34. The method of claim 30, wherein the anti-parasitic agent is effective against an endoparasite selected from the group consisting of nematodes, roundworms, Ancylostoma, Anecator, Ascaris, Strongyloides, Trichinella, Capillaria, Toxocara, Toxascaris, Trichiris, Enterobius, and filarial worms.

35. The method of claim 30, wherein the anti-parasitic agent is selected from the group consisting of an insecticide, a fungicide, a bacteriocide and combinations thereof.

36. The method of claim 30, wherein the concentration of the anti-parasitic agent in the core material is from about 10% to about 100% by weight of the core.

37. The method of claim 30, wherein the concentration of the anti-parasitic agent in the core material is greater than about 20% by weight of the core.

38. The method of claim 30, wherein the concentration of the anti-parasitic agent in the core material is from about 25% to about 60% by weight of the core.

39. The method of claim 30, wherein the aqueous dispersion comprises water.

40. The method of claim 30, wherein the shell wall is substantially hydrophilic and does not dissolve in water.

41. The method of claim 30, wherein the shell wall is selected from the group consisting of alginates, proteins, carbohydrates, gelatin, and cellulose or modifications thereof.

42. The method of claim 30, wherein the shell wall is comprised of a dextrin selected from cyclodextrin and maltodextrin.

43. The method of claim 30, wherein the shell wall is comprised of wax.

44. The method of claim 30, wherein the shell wall is comprised of an interfacial polymerization between two phases.

45. The method of claim 30, wherein the topical composition is applied to a cat or dog on a monthly basis.

46. The method of claim 30, wherein the topical composition is applied to a cat or a dog on a weekly basis.

47. The method of claim 30, wherein the topical composition is applied to a cat or a dog four times a year.

48. The method of claim 30, wherein the amount of anti-parasitic agent administered to the animal is from about 1.0 to about 220 mg per kg of the animal's body weight.
